(19) United States
(12) Patent Application Publication
(10) Pub. No.: US 2013/0220822 A1
(43) Pub. Date: Aug. 29, 2013

(54) METHOD AND SYSTEM FOR CATALYSIS

(71) Applicants: Bjorn Winther-Jensen, Mount Waverley Victoria (AU); Douglas MacFarlane, Brighton East Victoria (AU); Orawan Winther-Jensen, Mount Waverley Victoria (AU)

(72) Inventors: Bjorn Winther-Jensen, Mount Waverley Victoria (AU); Douglas MacFarlane, Brighton East Victoria (AU); Orawan Winther-Jensen, Mount Waverley Victoria (AU)

(21) Appl. No.: 13/883,833

(22) PCT Filed: Nov. 4, 2011
(86) PCT No.: PCT/AU11/01414

§ 371 Date: May 9, 2013

(30) Foreign Application Priority Data
Nov. 8, 2010 (AU) 2010904943

(51) Int. Cl. C25B 1/00; C25B 3/02; H01G 9/20; H01M 4/86; C25B 11/04

(52) U.S. Cl. CPC C25B 1/003; H01M 4/8652; C25B 11/04; H01G 9/20; C25B 3/02
USPC 205/340; 502/159; 502/1; 204/290.11

(57) ABSTRACT

A catalyst comprising a first conjugated polymer material that forms an interface with a second material, wherein charge is separated from photo excited species generated in one or both of the first and second materials and subsequently participates in a reaction, electro-catalytic reactions or redox reactions.

### FIELD OF INVENTION

The present invention relates to the field of electrochemistry, particularly electrochemical or photo electrochemical catalysts and electrodes comprising the catalysts suitable for use in electrochemical cells such as batteries and fuel cells. Even more particularly the present invention relates to photocatalysts that can be used with bias as part of electrocatalytic electrodes or without bias for direct photo catalysts (such as water oxidation or splitting).

In one form, the invention relates to an electrochemical electrode. In one particular aspect the present invention is suitable for use as a photo-electrocatalytic electrode.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

While the present invention will principally be described with reference to electrodes comprising poly(3,4-ethylenedioxy thiophene) (PEDOT), polyterthiophene (PTTh), polybithiophene (PBTh) and combinations thereof however it should be appreciated that the present invention is not limited to those polymers or combinations of polymers and that other polymers may be suitable.

Electrocatalysis is a process by which catalytic action enhances an electrochemical reaction. For example, eledrocatalysis may enhance the current for oxidation or reduction of a species in solution. Electrocatalysis may be biased, that is it includes the use of electrodes or without bias that is, it has a direct driving effect on an electrochemical reaction. Photo catalysis uses visible light to drive the enhancement of the electrochemical reactions. The difference between photo-electrochemical electrodes and photo-electrocatalytic electrodes is discussed in the following paragraphs.

### Photo Electrochemical Electrodes

Photo electrochemical electrodes are often used in electrochemical cells to store or convert chemical energy and make it available in an electrical form. Electrochemical cells include energy sources such as batteries and fuel cells.

For example, the direct conversion of visible light to electricity was described as early as 1839 by Becquerel (Becquerel E, Comp. Rend. Ac. Sci 9, 561 (1839)). Becquerel observed current passing through an AgCl—Pt electrode/electrolyte/counter-electrode system when the AgCl coated Pt electrode was illuminated. Similar cells have since been described wherein various elemental and compound semiconductors have been used as photoactive electrodes. A Photo-Electrochemical Cell (PEC) typically comprises an electrode comprising a semi-conductor of the n- or p-type having suitably wide bandgap for efficient utilisation of solar energy, in combination with an additional electrode and an electrolyte comprising a redox couple. The additional electrode is a storage electrode adapted to supply converted energy as electricity when the photo-electrode is not illuminated. A PEC of this type is described, for example in U.S. Pat. No. 4,064,326.

Most work in this area has focussed on semiconductors that have a wide band gap, most typically inorganic semiconductors. Oxides of Ta, Ti, Sb, Sn or W oxides have been very stable photo-electrodes but can only utilise UV or near-UV radiation and are unsuitable for solar energy conversions. Other electrodes used in such devices often undergo irreversible electro-chemical reaction of the electrode material (ie the electrode is attacked by the electrolyte or the redox couple in the electrolyte). This is true of CdS, SI, Ge, GaP and other inorganic electrodes.

### Photo Electrocatalysis

In essence, photo-electrocatalysis can be used to drive chemical reactions, not just generate electricity.

Electrocatalytic electrodes of the past have been made from a wide range of materials, typically inorganic oxides. Some organic based electrodes have also been created such as those described in U.S. Pat. No. 4,833,062, comprising a combination of conductive filler (such as carbon black, graphite or metal powder) in a resin matrix or binder to produce the desired conductivity, strength and surface properties. These electrodes may be modified to impart the desired surface characteristics in the electrolyte solution in which they are immersed.

### Heterojunctions and Homojunctions

A heterojunction is the interface between two layers or regions of dissimilar semiconductor materials. The semiconductor materials of a heterojunction have unequal band gaps, in contradistinction to a homojunction.

Heterojunction materials are well known in devices such as solar cells which convert sunlight directly to electrical energy using the photo-voltaic effect. In essence, the photons in sunlight are absorbed by one of the semiconductor materials (typically silicon), knocking electrons from their atoms and creating a ‘hole’ in the semiconductor. The electrons flow through the semiconductor material to form an electric current, the structure of the material permitting electron movement in only one direction.

Inorganic materials are commonly used in this application. For example, solar cells comprising a CdTe thin film plus semiconductor layer are well known and copper indium gallium selenide is a direct-bandgap material of extremely high efficiency for converting sunlight to electricity.

Organic solar cells are also known but have low efficiency. They are manufactured from thin films of organic semiconductors such as polymers and small molecules such as polyphenylene vinylene. Organic semiconductor solar cells differ from the inorganic versions in that they do not rely on the large built-in electric field of a PN junction to separate the electrons and holes created when photons are absorbed. The active region of an organic device consists of two materials, one which acts as an electron donor and the other as an acceptor. When a photon is converted into an electron hole pair, typically in the donor material, the charges tend to remain bound in the form of an exciton, and are separated when the exciton diffuses to the donor-acceptor interface. The short exciton diffusion lengths of most polymer systems tend to limit the efficiency of such devices. Nanostructured interfaces, sometimes in the form of bulk heterojunctions, can improve performance.

Accordingly, while the organic bulk hetero-junction effect is known and used in photo-chemical generation of electricity it has not hitherto been used for photo-electrocatalysis. In particular bulk hetero junction effect of organic electrodes has not been used for electrocatalysis. Organic electrodes are often cheaper and more economic to produce as compare with inorganic (particularly rare-earth) electrodes. Organic electrodes are typically processed from solution, and can often be fabricated by processes derived from the printing industry making it possible to carry out inexpensive, large scale electrode production.

### SUMMARY OF INVENTION

An object of the present invention is to provide a novel method of catalysis. In particular it is an object to provide a novel method of using conjugated polymers for photo catalytic reaction or photo-electrocatalytic reaction.

A further object of the present invention is to alleviate at least one disadvantage associated with the related art.

It is an object of the embodiments described herein to at least provide a useful alternative to related art systems.

In a first aspect of embodiments described herein there is provided a catalyst comprising, a first conjugated polymer material that forms an interface with a second material, wherein charge is separated from photo excited species generated in one or both of the first and second materials and subsequently participates in an electro-catalytic reaction.

In a second aspect of embodiments described herein there is provided an electrode comprising the aforementioned catalyst.

Thus the catalyst of this invention can operate in two possible modes

(i) the catalyst is applied to an electrode which is part of an external electrical circuit connected to a second electrode such that an electrochemical reaction takes place on each electrode. In this mode the catalyst act as a photo electrocatalyst; and

(ii) the catalyst, either dispersed in a fluid or deposited on a substrate, is able to support both oxidation and reduction reactions. The interface supports separation of the photoexcited electron and a hole such that each is able to participate in an electrochemical reaction at the interface of the catalyst without being transferred to a second electrode. The catalyst thus supports a complete redox reaction. In this mode the catalyst therefore acts as a photo redox catalyst.

### Suitable Materials

Typically, at least one of the materials for use in the electrode of the present invention is photo sensitive.

The first material may be combined with the second material in any convenient manner that provides a suitable interface, but preferably the first material and the second material are combined in an interpenetrating network (IPN). The areas in which the two materials interface may also be referred to as a heterojunction. For example, when the first material and second material are polymers they can be synthesised together as an IPN. Both the first material and the second material may be combined with a support. For example they may be coated on a porous organic material such as Goretex® or similar synthetic material. Any support used may optionally include a layer of a ‘current collector’. In a particularly preferred embodiment the conductor is a metal of generally low reactivity such as Au or Ti. Other metals such as Cu, Ag and Ni are suitable for use as current collectors, but have a higher tendency to react with electrolytes comprising metal salts. The person skilled in the art will appreciate that metals are not the only materials suitable for use as a current collector and certain non-metals such as carbon are suitable. The carbon layer may comprise any suitable form such as nanostructures such as carbon ion tubes, ribbons or sheets.

Typically the second material in the catalyst are chosen from the group comprising conjugated organic species such as polymers, dyes containing a conjugated pi-system, carbon, organic semiconductors or combinations thereof. Some inorganic materials will also be suitable and will typically be conjugated, however some unconjugated inorganic materials may also be suitable if they exhibit strong absorption in the visible range of the electromagnetic spectrum (for example, due to transition of electrons between d-orbitals). Carbon suitable for use as a first or second material may be of any convenient conformation such fullerenes (particularly C60), grapheme, graphite, carbon nano tubes, ribbons, sheets or other nanostructures. Suitable organic semiconductors include, for example charge transfer complexes and solid/polymeric ion-conductors.

In a preferred embodiment both the first and second materials in the interface are conjugated polymers chosen from the group including poly(3,4-ethylenedioxy thiophene) (PEDOT), polyterthiophene (PTTh), polybithiophene (PBTh) and combinations thereof. In another preferred embodiment the first material is a conjugated polymer, and the second material is either carbon or some other organic semiconductor.

### Additional Materials

The first material and/or the second material may comprise a single chemical species (such a single conjugated polymer) or be combined with a third material. For example, a conjugated polymer material and the second material may be combined with other conjugated polymers, non-conduction polymers or non-polymeric organic materials. These additional organic materials may perform a variety of functions, such as acting as charge mediators or light harvesters or they may enhance transport of species (reactants and products) to and from the active catalytic sites. Transport enhances could include, for example, polyethylene glycol (PEG) or polyacids. Alternatively or in addition, the first and second materials conjugated polymer may be combined with inorganic materials. These inorganic materials could include, for example, semiconductors such as metal oxides (eg ZnO) and metal sulphides (eg CdS) or metals. The inorganic materials may perform a range of functions such as securing charge separation, or otherwise enhancing the system such as, in respect to conversion and long-term stability.

Typically the charge from the photo excited species comprises an electron and ‘hole’ and either the electron, the hole or both participate in the electro-catalytic reaction.

The charge may participate in second and subsequent electro-catalytic reactions.

In another aspect of embodiments described herein there is provided a method of catalysis of an electrochemical reaction, the steps comprising;
(i) forming a catalyst having a first conjugated polymer material interfacing with a second organic conducting material,
(ii) allowing light to impinge on the catalyst to generate photo excited species in either or both of the first and second materials,
(iii) separating charge from one or both of the first and second materials, and
(iv) using the separated charge as the catalyst in an electro-catalytic reaction.

In a preferred embodiment, the method further comprises the step of applying the catalyst to an electrode. The catalyst may be applied to the electrode subsequent to, or simultaneous with formation of the catalyst.

### Suitable Electro-Catalytic Reactions

The catalyst of the present invention can be used for a variety of chemical reactions, typically REDOX reactions such as photo-reduction of CO₂ or H₂O or oxidation of hydrogen or methanol. Photo-reduction of CO₂ is environmentally useful because It removes a harmful greenhouse gas. These reactions may be carried out with, or more typically without bias.

Many other suitable reactions will be readily apparent to the person skilled in the art, including SO₂ oxidation reactions, oxygen reduction, formic acid oxidation, reduction of bonds (such as reduction of C—O and C═C bonds in chemicals and fuel production (replacing traditional hydrogenation processes)), reduction of redox couples normally found in dye-sensitive solar cells (such as I₃), oxidative polymerisation (for example, of conducting polymers) and N₂ reduction.

The electrode and method of the present invention could also be used in a variety of applications, such as an actuator in light driven switchable reactions.

Other aspects and preferred forms are disclosed in the specification and/or defined in the appended claims, forming a part of the description of the invention.

### Advantages

In essence, embodiments of the present invention stem from the realization that two organic materials having different work-function can form an interface therebetween that facilitates charge transport and charge separation. For example two polymers, specifically conjugated polymers, can be synthesized as an interpenetrating network and the interface thereby established may be used to separate the charge from a photo excited species and directed to catalysis of an electrochemical reaction.

Advantages provided by the present invention comprise the following:
the ability to use a free, environmentally sound energy source (sunlight) to drive a chemical reaction;
the harnessing of sunlight for a novel use other than electricity generation;
no precious metals are required for the manufacture of the electrode;
ease of production—for example the electrode may be formed by printing or other convenient means;
improved cost effectiveness compared to electrodes constructed of precious metals or using many fabrication processes of the prior art.

The present invention can be used to provide a renewable source of both hydrogen and electricity and thus may have application to a range of products including;
fuel cells,
water splitting cells (simultaneously oxidizing and reducing water),
tandem cells (converting photons to hydrogen),
biohydrogen devices (producing hydrogen from wheat starch based food by fermentation),
solar cells, and
batteries.

These products can be used in a range of markets including transport and grid power—the efficiency of hydrogen can be two to three times that of conventional fossil fuel combustion, meaning improvements in efficiency of electricity generation for grid power and transport. Fuel cells offer additional advantages of being readily adaptable to different applications and being capable of operating quietly with fewer moving parts than other electricity generation means. While individual fuel cells produce only small voltages, they can be stacked together to provide dramatically increased energy density. For example, depending on the stacking, fuel cells can generate 50 to 100 W (suitable for laptop computers), 1 to 5 kW (suitable for domestic appliances such as a TV, fridge, washing machine etc), 50 to 125 kW (suitable for transport applications), or 1 to 200 MW (suitable for grid power).

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further aspects of embodiments of the present application may be better understood by those skilled in the relevant art by reference to the following non-limiting disclosure and the accompanying illustrations in which:

FIG. 1 is a plot illustrating constant potential measurements at 0.4V vs SCE (a) with no light, and (b) with light;

FIG. 2 is a plot illustrating pseudo-steady state measurements of PEDOT/PBTh on Au coated Goretex in phosphate buffer pH 4.3 at a scan rate of 0.167 mV/s (a) with no light, and (b) with light;

FIG. 3 is a plot illustrating Nernstian dependence on change in pH for PEDOT/PBTh on Au coated Goretex in contact with air, using an electrolyte of 0.1M NaPTS at a scan rate of 0.167 mV/s (a) with no light, and (b) with light;

FIG. 4 is a plot for PEDOT/PTTh/PEG 0.5 in 0.1M Na₂HPO₄, bubbling air, at a scan rate of 1 mV/min (a) with not light, and (b) in light;

FIG. 5a is a UV-Visible spectrum of (b) PEDT/PBTh deposited on PET foil compared to the pure components (a) PEDT and (c) PBTh; FIG. 5b is a UV-Visible spectrum of (b) PEDT/PTTh deposited on PET compared to (a) pure PEDT and (c) PTTh;

FIG. 6a depicts cyclic voltammograms of PEDOT/PBTh deposited on Pt coated PET foil (a) compared to CV's of the constituents PEDOT (b) and PBTh (c); FIG. 6b depicts cyclic voltammograms of PEDOT/PTTh deposited on Pt coated PET foil compared to CV's of the constituents PEDOT and PTTh.

FIG. 7 is a plot of hydrogen production on PEDOT/PBTh on Au coated Mylar in 1M H₂SO₄ under nitrogen (a) with no light, and (b) with light.

FIG. 8 is a plot of oxygen evolution over time for a catalyst comprising PEDOT:PTTh in the ratios (a) 1:0.25, (b) 1:0.5, (c) 1:0.75 and (d) 1:4.

FIG. 9 is a plot of formate oxidation from NaFormate solutions on PEDOT/BB composite at concentrations of (a) 1M, (b) 5M, and (c) 5M under illumination at a scan rate of 5 mV/s.

FIG. 10 is a flow chart illustrating implementation of the catalyst for hydrogen production.

### DETAILED DESCRIPTION

The photo-electrocatalysis of the present invention is further described with reference to use of the conjugated polymers poly(3,4-ethylenediosy thiophene) (PEDOT) and polyterthiophene (PTTh) in-situ polymerised into an interpenetrating network (IPN) of the two polymers.

This method of combining the two conjugated polymers has been previously disclosed; however it has not hitherto been use for electro-catalytic or photo-catalytic applications. When light is shone on the IPN of the polymers, electrons in the reduced PTTh are excited into the conduction band. PEDOT acts as a hole conductor adjacent the PITH; thus providing efficient charge separation by virtue of the holes moving into the PEDOT via the interface while electrons are able to move in the PTTh conduction band. When the PEDOT/PTTh IPN is immersed in a suitable aqueous electrolyte and a bias potential applied, the holes ‘pumped’ into the PEDOT due to the light emitted on the sample, are able to drive a reaction, such as the oxidation of water.

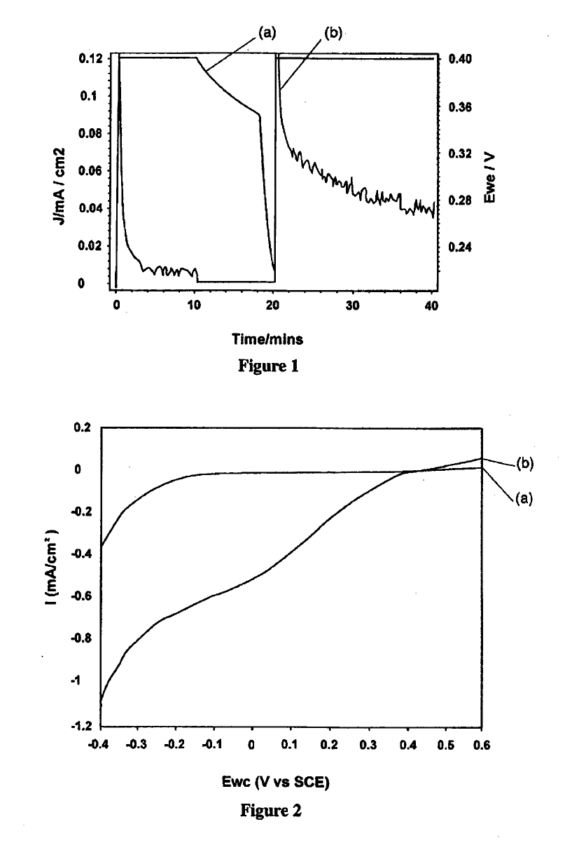

For example, FIG. 1 illustrates the conversion current of PEDOT/PTTH in water with, or without light. When no light is provided, no current is expected. During exposure to light a photocurrent appears and increased oxygen levels are measured in the head-space above the electrolyte.

For the ‘reverse’ reaction, that is, oxygen reduction, the interface works the same way as described above, but in this case the electrons in the PTTh conduction band participate in the oxygen reduction and PEDOT takes the role of transporting charge (holes) to the outer circuit.

FIG. 2 shows pseudo steady state measurements for PEDOT-polybithiophene (PBTh) on Au coated Goretex in contact with air with and without light.

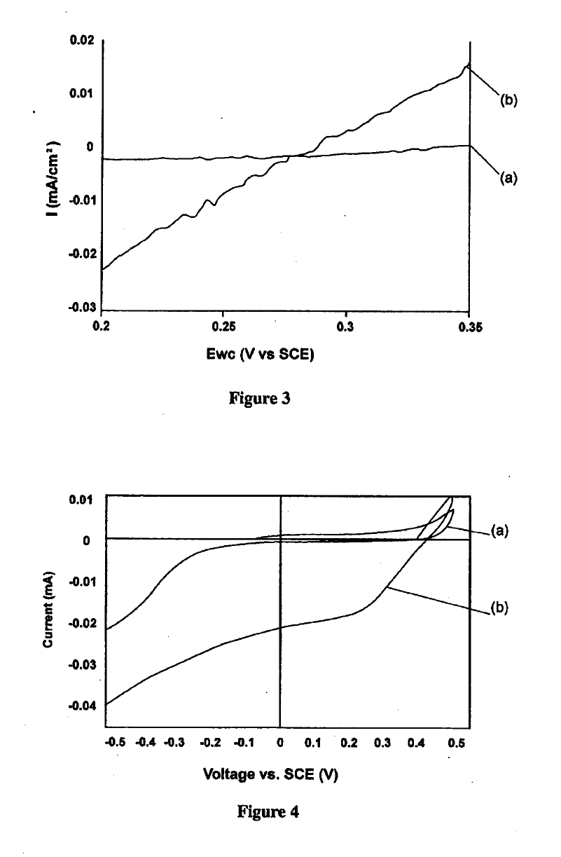

At potentials below ˜0.4V vs SCE the reduction of oxygen is enhanced significantly due to the light. At potentials below ˜−0.15V vs SCE the well-known oxygen reduction on neat PEDOT adds to the overall reduction of oxygen. At potentials above ˜0.4V vs SCE a positive, oxidising current is seen as a consequence of water oxidation. At neutral pH, the potential where the I-V is crossing zero current is decreased to about 2.8V vs SCE reflecting the Nernstian dependence to change in pH (FIG. 3).

Optimally the interface is ‘tuned’ to different REDOX reactions in order to avoid recombination and enhance charge transport to the circuit and to the reaction media. A large number of REDOX reactions may be suitable for use with the present invention, including CO₂ and water reduction as well as hydrogen and methanol oxidation.

The results outlined above were achieved with a PEDOT:PTTTh (PBTh) ratio of 1:1. Further optimisation of ratios, hydrophilicity, other conducting polymers, electrolytes and so forth are possible and can be directed to suit different REDOX reactions.

It is obvious that the chosen materials described here may not be optimal. In particular, it is well known that PEDOT can undergo over-oxidation which is an obvious concern in the system described. In addition, the use of non-polymeric organic materials (charge mediators, light harvesters etc) as well as combination with inorganic materials (eg semiconductor materials such as metal oxides and metal sulphides like ZnO and CdS and also metals to secure charge separation) may be able to enhance the system with respect to conversion and long-term stability.

The invention will now be further described with reference to the following non-limiting examples:

### Example 1

### Interpenetrating Networks (IPNs) Between Two Conjugated Polymers

The formation of Interpenetrating Networks (IPNs) between two conjugated polymers may be realised for example, in a two-step process where both steps are driven by oxidative polymerization. (B. Winther-Jensen, K. West Synthetic Metals 148 (2005) 105-109). In the first step, one conjugated polymer is chemically polymerized (CP) using an excess of oxidant. In the next step, the remainder of the oxidant is used to polymerise the second conjugated polymer by vapour phase polymerization (VPP). (B. Winther-Jensen, K. West, Macromolecules 37 (2004) 5438-5443.) The CP/VPP terminology used here is neither particularly meaningful nor stringent, but follows a widely accepted practice for each of the individual polymerization techniques.

To carry out the CP step, a thin film of the reactants dissolved in butanol or ethanol is cast onto the substrate (eg the surface of a glass slide, a PET foil, gold coated mylar, a conductive gas diffusion membrane or a platinum foil). The polymerisation starts when the sample is heated to ˜60° C. and the major part of the solvent is evaporated. Fe(III) tosylate is a preferred oxidant because it does not crystallize under these conditions and forms smooth, coherent films. The second step (VPP) is performed in the same way as previously reported for polypyrrole and polythiophenes. (B. Winther-Jensen, J. Chen, K. West, G. G. Wallace, Macromolecules, 37 (2004) 5930-5935)

Whereas, the amount of polymer synthesized in the CP step is determined by the amount of monomer present, the excess oxidant not consumed in the CP step determines the amount of polymer synthesized in the VPP step. To demonstrate that the proposed process can be used to form a wide range of conjugated polymer IPNs, the different combinations listed in Table 1 have been tried.

TABLE 1
Composition of conjugated polymer IPN's

| | Monomer polymerised | Monomer polymerised | |
|---|---|---|---|
| No. | in the CP step | in the VPP step | Abbreviation |
| 1 | Bi-thiophene | Pyrrole | PBTh/PPy |
| 2 | EDOT | Bi-thiophene | PEDOT/PBTh |
| 3 | EDOT | Ter-thiophene | PEDOT/PTTh |
| 4 | EDOT | Pyrrole | PEDOT/PPy |

The conjugated polymers in Table 1 include polymers with relatively high-oxidation potentials (PBTh and PTTh) that are in the reduced state under ambient conditions; a polymer with a low-oxidation potential (PEDOT) that will be in the conducting state under ambient conditions; and a polymer with an intermediate oxidation potential (PPy) that can be easily switched between the conducting and non-conducting states. To get high conductivities, the formation of PEDOT requires basic inhibition under the polymerization with Fe(III)tosylate. (B. Winther-Jensen, K. West, Macromolecules 37 (2004) 5438-5443)

For this reason, PEDOT can only be prepared in the CP step, and the basic inhibitor (pyridine) must be removed by heating (>1 h at 60° C.) before formation of the second polymer in the VPP step. Initial experiments were made with twice the stoichiometric amount of oxidant needed in the CP step. Because the monomers used consist of different numbers of hetero cycles, the ratios between the two polymers—both with respect to volume and to electro-active sites—are different for all the samples in Table 1.

3,4-Ethylenedioxythiophene (EDOT, Baytron M) and a 40% solution Fe(III) tosylate in butanol (Baytron C) was received from Bayer AG. All other chemicals were obtained from Aldrich and used as received.

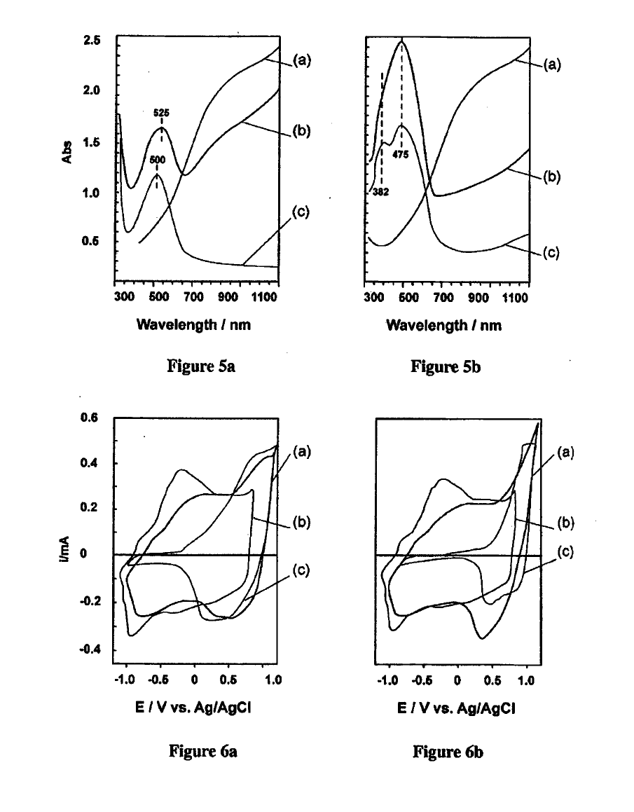

The UV-VIS spectra of the composites of poly-3,4-ethylenedioxythiophene with, polybithiophene and polyterthiophene are shown in FIG. 5 compared with the spectra of the pure constituents. The characteristic features of the IPN's are a combination of the features from the spectra of the pure components, with only minor changes in peak positions. This means that the IPN's with PEDOT and either PBTh or PTTh behave like an addition of the pure components. Also the CV's of the composites, see FIG. 6, appears to be straightforward combinations of characteristic features from the constituents, with small alterations that can be ascribed to a slightly slower kinetics of the IPN.

Specifically, FIG. 6(a) depicts cyclic voltammograms of PEDOT/PBTh deposited on Pt coated PET foil (black line) compared to CV's of the constituents PEDOT (grey line) and PBTh (broken grey line). FIG. 6(b) depicts cyclic voltammograms of PEDOT/PTTh deposited on Pt coated PET foil compared to CV's of the constituents PEDOT and PTTh. The cyclic votamagrms were carried out using an electrode area of 0.1 cm², sweep rate of 100 mV/s, with an electrolyte of 0.1 M TBAP in CH₃CN.

### Example 2

### Water Oxidation

The conjugated polymers PEDOT and PTTh were in-situ polymerized into an interpenetrating network (IPN) of the two polymers according to Example 1. As previously mentioned, when light is shone on the material, electrons in the reduced PTTh are excited into the conduction band. Having PEDOT as a hole conductor adjacent the PTTh offers the possibility of efficient charge separation, where holes move into the PEDOT via the interface while electrons are able to move in the PTTh conduction band. When the PEDOT/PTTh IPN is immersed in an appropriate aqueous electrolyte and a bias potential applied, the holes “pumped” into the PEDOT, due to the light emitted on the sample, are able to drive the oxidation of water. The aqueous electrolyte should be made appropriate and preferably optimised with regard to pH, salinity and soforth.

As mentioned previously FIG. 1 shows the conversion current of PEDOT/PTTh in water (0.1M NaPTS, pH adjusted to 8) through constant potential measurements at 0.4V vs SCE in 0.1M NaPTS with pH adjusted to 8 without (0 to 10 min) and with light (1 sun) (20 to 40 min).

At 0.4V (vs SCE) the system is below the themodynamic redox potential for the onset of water oxidation at pH=8 (0.517 V) and no current should be expected, as is observed in the dark experiment. On exposure to light a photocurrent is generated and increased oxygen levels are measured in the head-space above the electrolyte during operation. Thus the process seen can be assigned to oxidation of water.

### Example 3

### Oxygen Reduction

For the “reverse” reaction of water splitting, that is, oxygen reduction, the interface works the same way as described above, but in this case the electrons in the PTTh conduction band participate in the oxygen reduction and PEDOT is takes the role of transporting charge (holes) to the outer circuit.

The efficiency of fuel cells is largely dependant on the electro catalytic reduction of oxygen at the cathode. Traditionally platinum based catalysts have been used and they are still the preferred material for proton conducting membrane fuel cells, which dominate the low temperature field. PEDOT is a possible alternative to platinum for oxygen reduction, but relatively high overpotentials for the reaction under neutral and acidic conditions has limited PEDOT's utility to the highly alkaline fuel cells.

To study the interface between materials of the present invention as potential candidates as photo enhanced catalysts, attempts were made to lower the overpotential of the oxygen reduction reaction by using conducing polymer composites. This could potentially form a basis for light enhanced fuel cells. PEDOT/PBTh and PEDOT/PTTh were examined, and showed similar behaviour with PEDOT/PTTh as the superior candidate.

FIG. 4 shows reduction of dissolved oxygen on a (PEDOT:PTTh 1:4):PEG 0.5 composite in 0.1M Na₂HPO₄, with bubbling air with and without illumination of the electrode (1000 lm, 3000K—similar power to 1 sun power). A decrease in overpotential of around 0.6V was observed.

Tests in full fuel cells showed an increase in operating potential under constant current load of more than 0.3V under light, confirming that the observed phenomena is real.

This example illustrates that interfacing of materials according to the present invention have the potential to work as photo enhanced electro-catalysts.

As previously described FIG. 2 shows pseudo steady state measurements (scan-rate 0.167 mV/s) of PEDOT-PBTh on Au coated-Goretex in contact with air in 0.1M phosphate buffer pH 4.3, with and without light.

At potentials below ˜0.4V vs SCE the reduction of oxygen is enhanced significantly due to the light. At potentials below ˜−0.15V vs SCE the well-known oxygen reduction on neat PEDOT adds to the overall reduction of oxygen.

It is worth noticing that at potentials above ˜0.4V vs SCE (at this pH) a positive (oxidizing) current is seen as a consequence of water oxidation.

At neutral pH, the potential where the I-V is crossing zero current is decreased to about 2.8 V vs SCE reflecting the Nemstian dependence to change in pH (FIG. 3).

The result of the “bi-functional” interface under light is, as seen in FIGS. 4 and 5, an I-V curve with a linear shape through zero current, indicating that both reactions (i.e. oxygen reduction and water oxidation) is occurring with no or very little overpotential.

### Example 4

### Proton Reduction—Hydrogen Production

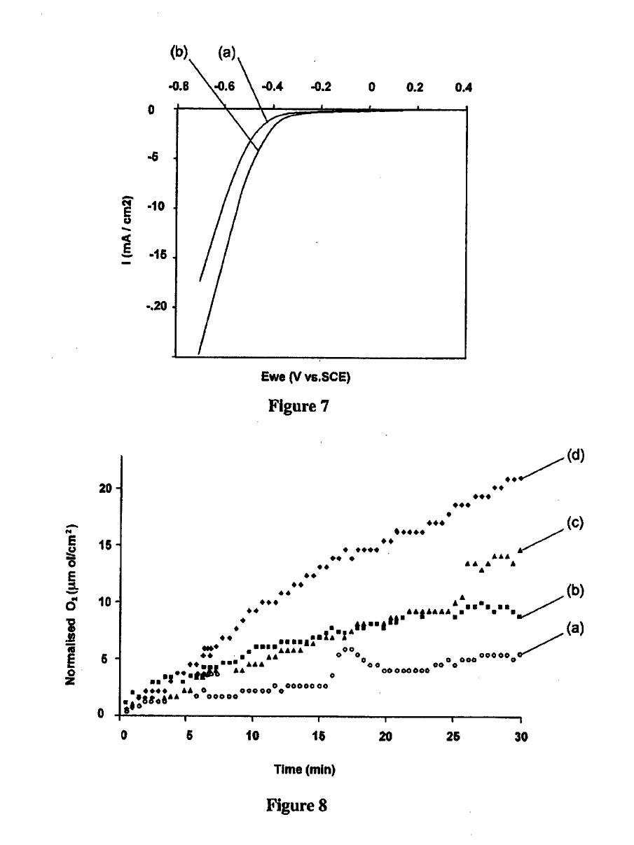

When testing the interface for proton reduction in 1M H2SO4 a photovoltage of about 80 mV is seen, shifting the reduction potential under light to more positive values. A larger photovoltage may be expected, but obviously the interface has to be “tuned” to different REDOX reactions in order to avoid recombination and enhance charge transport to the circuit and to the reaction media. FIG. 7 depicts hydrogen production on PEDOT-PBTh on Au coated Mylar in 1M H2SO4 under nitrogen.

### Example 5

### Photo-Catalytic Water-Splitting

Two conducting polymers PEDOT and poly(terthiophene) (PTTh) were polymerised as IPNs in various ratios and the ability of these composites to split water under irradiation (without applied potential) was investigated. The increase in oxygen content in the headspace of a sealed cell was measured over time. The oxygen evolution during illumination for various ratios of PEDOT:PTTh in phosphate buffer 0.1M is recorded in FIG. 8.

The plot illustrates the increase in oxygen production with increasing proportions of PTTh which acts as the light harvester in the PEDOT/PTTh system.

The y-axis of the plot records oxygen production normalised to the amount (mass) of active composite to allow comparison of the composites with other (inorganic) photo-catalysts. The best result for PEDOT/PTTh in this example at ph 7 is ˜50 mmol O₂/hour/gm of active materials. This compares with ˜10 mmol O₂/hr/gm (with similar light intensity) for the best inorganic materials reported.

### Example 6

### (Photo) Electro Catalytic Oxidation of Formate

This example is similar to Example 2 except that an oxidative reaction is catalysed and a different combination of materials is used.

Formate oxidation is one of the possibilities for ‘fuel’ reactions in ‘non-hydrogen’ fuel cells. Traditional platinum based catalysts are used for the reaction and conducting polymers have so far shown no sign of catalytic activity for the reaction. A composite of PEDOT was prepared with a conjugated dye known as ‘brilliant blue’ (see Structure 1: ethyl-[4-[[4-[ethyl-[(3-sulfophenyl)methyl]amino]phenyl]-(2-sulfophenyl)methylidene]-1-cyclohexa-2,5-dienylidene]-[(3-sulfophenyl)methyl] azanium).

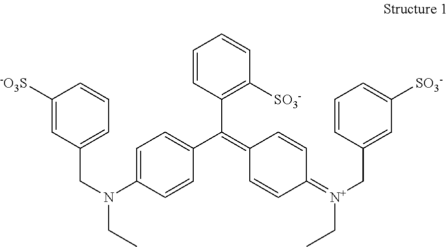

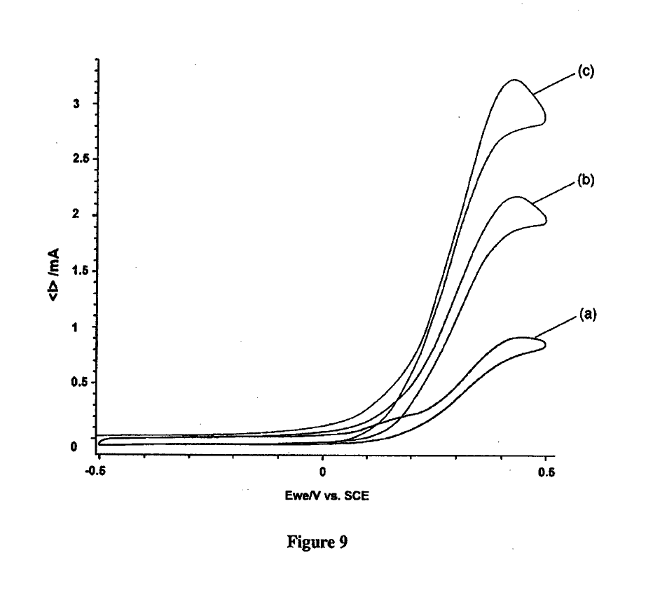

The composite of PEDOT and brilliant blue dye was electrochemically pre-oxidised to create a redox functional phenol group in the dye component of the interface material. The interface was confirmed by spectroscopy. The phenol functionality serves the role of mediator for the oxidation of formate. FIG. 9 shows the electrochemical oxidation of formate on the composite in 1M (blue curve) and 5M (red curve) sodium formate solution. The green curve is the light enhanced oxidation in 5M solution.

This example illustrates that oxidation reactions can also be catalysed by materials according to the present invention and that the catalysis can be enhanced by light. Importantly it also illustrates that conjugated dyes can act as one of the components in the interface. This opens up the possibility of using the existing vast range of conjugated organic dyes having various chemical functionalities, in conjunction with conducting polymers.

### Example 7

### Implementation of Hydrogen Production

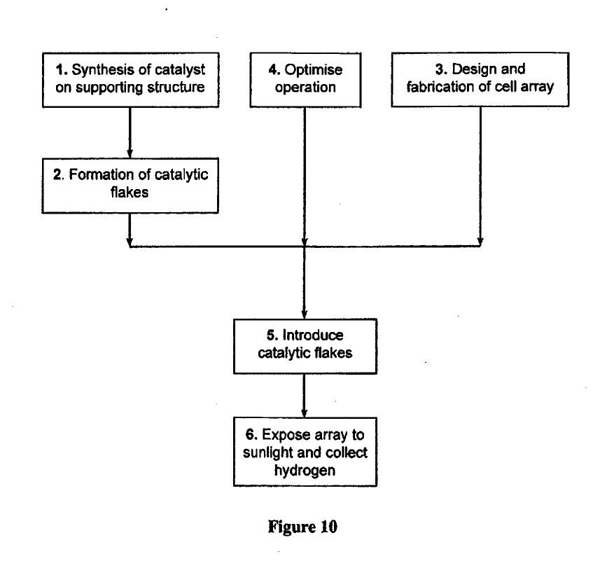

FIG. 10 is a flow chart illustrating use of a catalyst according to the present invention for hydrogen production, by the following steps:

1. A PEDOT/PTTh/PEG material composite is synthesised according to the present invention and held on a supporting substrate.

2. The material composite is released from the supporting substrate to form catalytic flakes.

3. A watersplitting cell array is designed and fabricated with H₂/O₂ gas separation. The water volume is optimised to the illumination area.

4, The supporting electrolyte and pH range are optimised to maximise hydrogen production.

5. The catalytic flakes are introduced to the water splitting array.

6. The water splitting array is exposed to sunlight, triggering hydrogen production. The hydrogen is captured and prepared for sale.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A catalyst comprising a first conjugated polymer material that forms an interface with a second material, wherein charge is separated from photo excited species generated in one or both of the first and second materials and subsequently participates in a reaction.

2. A catalyst according to claim 1 wherein the reaction is chosen from electro-catalytic reactions or redox reactions.

3. A catalyst according to claim 1 wherein the first material is chosen from the group of conjugated polymers comprising poly(3,4-ethylenedioxy thiophene), polyterthiophene, polybithiophene and combinations thereof.

4. A catalyst according to claim 1 wherein the second material is chosen from the group comprising polymers including conjugated polymers, dyes containing a conjugated pi-system, carbon, organic semiconductors, or combinations thereof.

5. A catalyst according to claim 1 wherein the second material is chosen from inorganic species exhibiting d-d orbital transitions.

6. A catalyst according to claim 1 wherein the first material and the second material are both conjugated polymers.

7. A catalyst according to claim 1 which is combined with a support.

8. A catalyst according to claim 1 which further comprises a third material that performs a function chosen from charge mediation, light harvesting or species transport enhancement.

9. An electrode comprising a catalyst according to claim 1.

10. A method of catalysis, the steps comprising;
(i) forming a catalyst according to claim 1,
(ii) allowing light to impinge on the catalyst to generate photo excited species in either or both of the first and second materials,
(iii) separating charge from one or both of the first and second materials, and
(iv) using the separated charge as the catalyst in a reaction

11. A method according to claim 10 wherein the reaction is chosen from electrocatalytic reactions or redox reactions.

12. A method according to claim 10 which further comprises the step of applying the catalyst to an electrode, subsequent to or simultaneously with step (i).

13. A catalyst according to claim 1 when used in a reaction chosen from the group comprising, water splitting, SO₂ oxidation reactions, oxygen reduction, formic acid oxidation, reduction of bonds in chemicals and fuel production, reduction of redox couples in dye-sensitive solar cells, oxidative polymerisation and N₂ reduction.

14. A catalyst according to claim 1 when used in a product chosen from the group comprising fuel cells, tandem cells, biohydrogen devices, solar cells and batteries.

15. An electrode comprising the catalyst of claim 13.
